(19) United States
(12) Patent Application Publication
(10) Pub. No.: US 2002/0068556 A1
(43) Pub. Date: Jun. 6, 2002

(54) Remote control

(75) Inventor: Daniel Brown, London (GB)

Correspondence Address: FRISHAUF, HOLTZ, GOODMAN &, LANGER & CHICK, PC, 767 THIRD AVENUE, 25TH FLOOR, NEW YORK, NY, 10017-2023, US

(73) Assignee: APPLIED PSYCHOLOGY RESEARCH LIMITED, London (GB)

(21) Appl. No.: 09/945,862

(22) Filed: Sep. 4, 2001

(30) Foreign Application Priority Data
Sep. 1, 2000 (GB) 0021530.1

(51) Int. Cl. H04M 3/00

(52) U.S. Cl. 455/420; 455/41; 455/419

(57) ABSTRACT

A unit for mounting on a user's forearm comprises at least one sensor for detecting movement of a user to which the unit is mounted and a wireless communication device for transmitting a signal in response to such movement. The unit is ideally suited as a remote control device for controlling electronic apparatus such as domestic entertainment apparatus.

The present invention relates to remote control of electronic apparatus such as domestic entertainment apparatus. The invention also relates to a control unit for such apparatus and to a method for controlling a processor to provide such interface functionality. Remote control apparatus for domestic appliances such as televisions, hi-fi and video recorders are well known. These are usually in the form of a rectangular box suitable for hand-held operation. At least one side of the box carries a number of user-actuable buttons. When these buttons are operated by the user a signal is transmitted, typically by way of infra-red (IR) light to the apparatus to be controlled.

The main drawbacks of this system, with which the reader is likely to be familiar, are the requirement to look at the remote control device when it is desired to use it and the complexity of operation. The interface that it provides is not intuitive and this is particularly significant in the field of interactive TV.

It is an object of the present invention to provide remote control which ameliorates the above disadvantages.

According to a first aspect of the present invention, there is provided a unit for mounting a user's forearm comprising at least one sensor for detecting movement of a user to which the unit is mounted and a wireless communication means for transmitting a signal in response to such movement.

By providing a unit which may be mounted to the user's body and is responsive to movement thereof, a much more intuitive unit can be provided. Since no eye contact is required with the unit, it is suitable for use with interactive television and similar applications.

The means for wireless comnunication are preferably a short-range radio transmitter. More preferably, these means comprise a BlueTooth™ transmitter.

In a preferred embodiment the present invention comprises a bracelet to be worn around the wrist of a user.

In a preferred embodiment the sensor means comprises at least one, and preferably two, acceleration sensors. The acceleration sensors preferably comprise accelerometers to allow the magnitude of the acceleration to be measured. Other sensor for movement may be used instead. One embodiment uses signals (such as ultrasound signals) transmitted from at least two points remote from the unit. The position of the unit relative to the two points can be determined by the timing of arrival of the signals at the unit (e.g. using FMCW radar “chirp” signals).

In a bracelet-style embodiment, the sensor means preferably comprises two accelerometers mounted on substantially opposite sides of the bracelet. This allows a twisting motion of the user's wrist to be detected, whereby the value from one accelerometer is substantially equal in value but opposite in polarity to that from the other accelerometer.

According to a second aspect of the present invention, there is provided a control unit for use with at least one unit according to the first aspect of the invention, the control unit comprising means for receiving a wireless communication from the user-mountable unit and means for deriving a plurality of control signals in response

The control unit is operable to receive signals from at least one of the user-mountable units. In a preferred embodiment the control unit is responsive to a number of such units. Signals from different units may readily be identified by means of different codes, different transmission frequencies and so on.

In a preferred embodiment the control unit comprises circuitry and is capable of performing routines to interpret the signals received from the unit or units. However, there is no reason why such functionality could not be located in the units themselves.

In another preferred embodiment the unit is further provided with a wireless transmitter, such as an IR transmitter, to interface with the apparatus to be controlled. Preferably the control unit can learn the signals to be transmitted from an existing remote control.

According to a third aspect of the present invention, there is provided a method of interpreting signals provided by a unit according to the first aspect of the invention, comprising comparing the output of the at least one sensor with a plurality of ranges of sensor output and outputting a control signal associated with a range into which the sensor value falls.

According to a fourth aspect of the invention, there is provided processor-readable instructions for instructing a processor to perform a method in accordance with the third aspect of the invention.

The present invention will now be described, by way of example, with reference to the accompanying figures, in which:

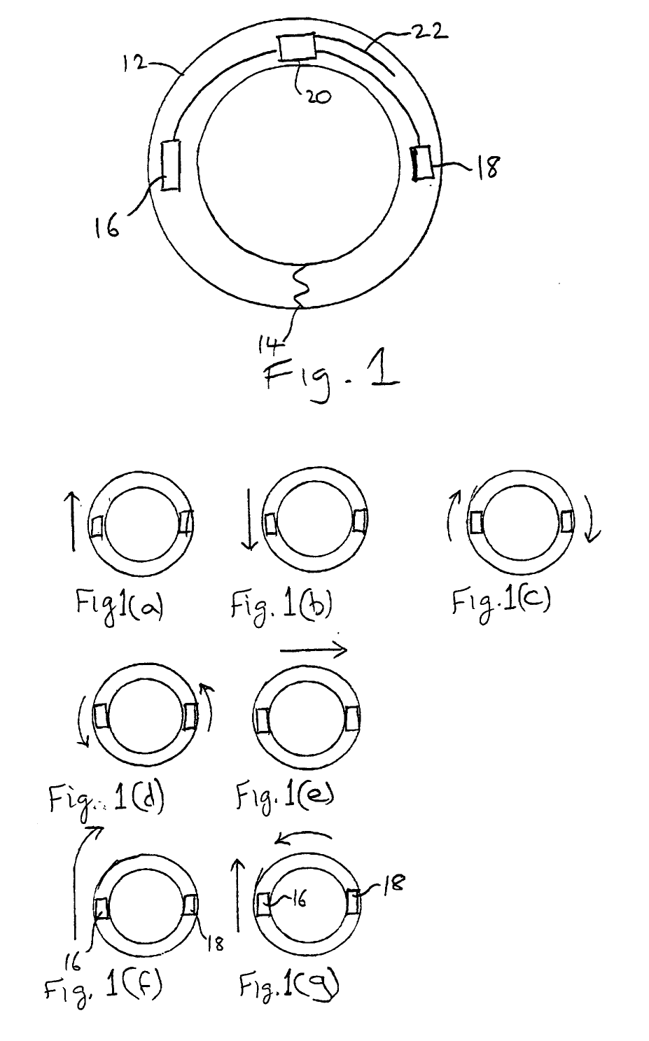

FIG. 1 shows a sectional view of a user-mountable unit in accordance with an embodiment of the invention;

FIGS. 1(a) to 1(g) show some movements associated with the unit shown in FIG. 1;

FIG. 2 shows a block schematic diagram of the unit of FIG. 1;

FIG. 3 shows a control unit such as could be mounted within a television set, for example, for receiving signals from the unit of FIG. 1;

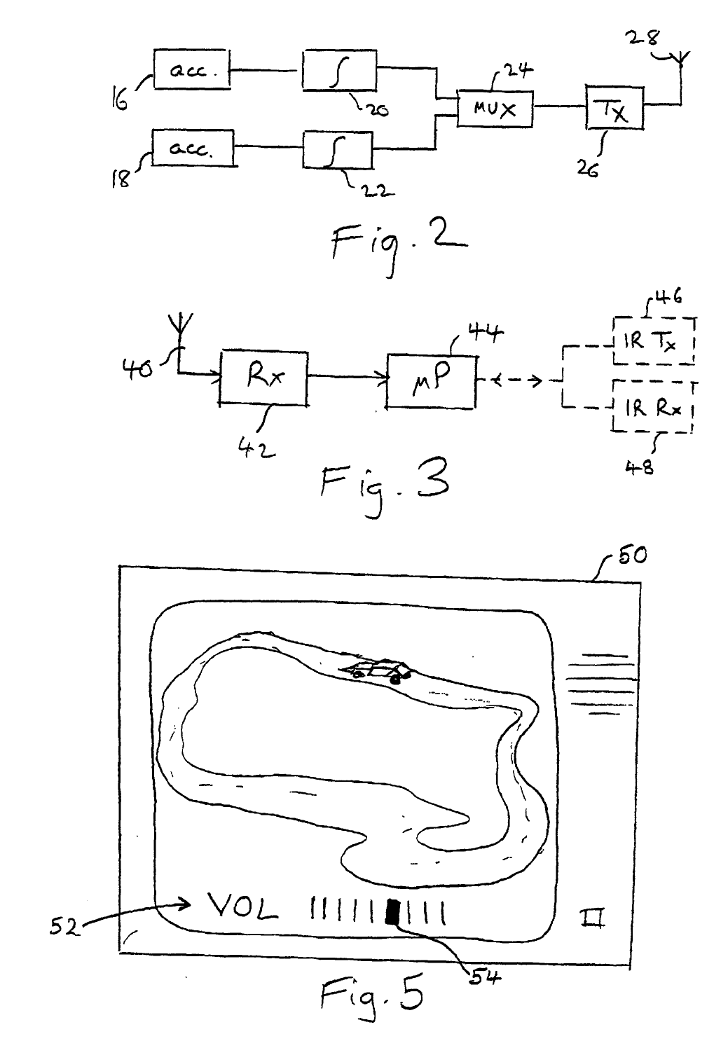

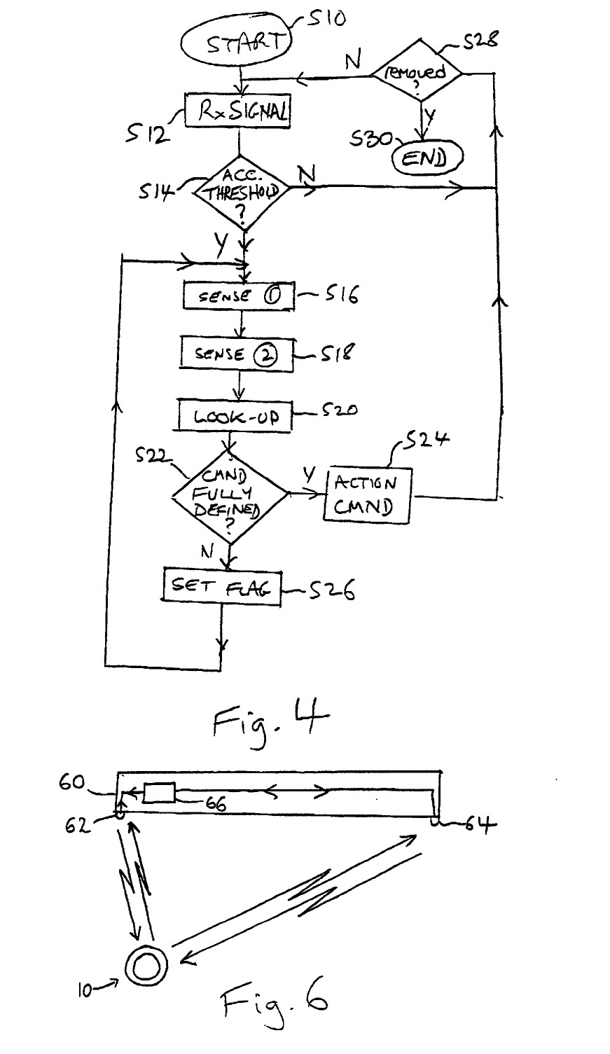

FIG. 4 shows a flow diagram of the steps performed by a processor in the control unit of FIG. 3;

FIG. 5 shows the screen of a television set together with a visual interface controlled by a unit in accordance with the present invention;

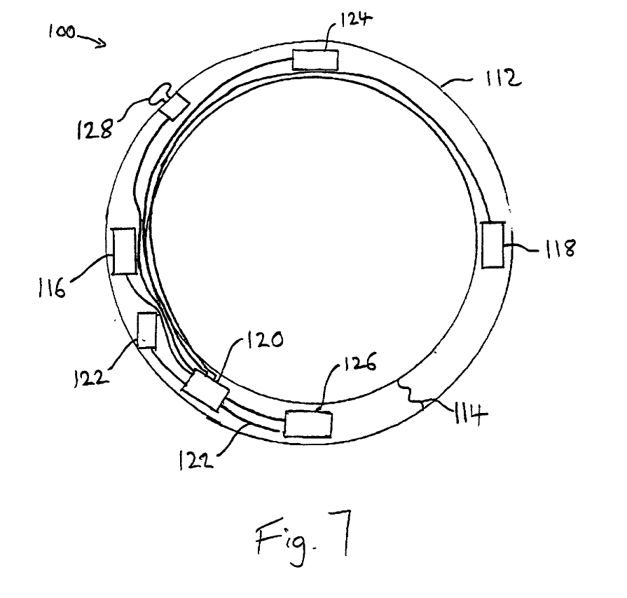

FIG. 6 shows a schematic view of a bracelet position locating system; and

FIG. 7 shows a sectional view of a user-mountable unit in accordance with another embodiment of the invention.

FIG. 1 shows a bracelet comprising a case 12 substantially round in shape but which may be opened by use of clasp 14 to allow a user to place it around his or her wrist. The exact form of the bracelet unit may be varied within the scope of the present invention. For example, the unit may be made to resemble a wristwatch having a flexible strap to which the various functional units are mounted. The strap may be closed by buckle means, an adjustable clasp or fabric joining means (e.g. Velcro™). Mounted within the unit are a pair of accelerometers 16, 18. Outputs from the accelerometers 16, 18 are connected to a transmitter unit 20, preferably a BlueTooth transmitter unit. The transmitter unit is connected to an antenna 22, preferably housed within the bracelet unit. A battery (not shown) would generally be used to provide pwer for the unit.

FIGS. 1(a) through (g) show some of the movements of a user's wrist which may be detected by the unit Arrows in the respective figures indicate the direction in which the user's wrist (and hence the unit) are moved. In FIG. 1(a) the user moves the unit upwards. In this case both of the accelerometers will output a signal of near-identical magnitude and of the same polarity. In FIG. 1(b) the user moves his wrist downwards. In this case, both of the accelerometers will output a signal having near-identical amplitude and the same polarity, but that which is opposite to the polarity output by upward movement. FIG. 1(c) illustrates a situation where the user rotates his wrist In this case the accelerometers will output a signal of near-identical amplitude but opposite polarity. This allows the control circuitry to distinguish a rotation from a linear movement. The direction of the rotation can be determined from the polarity of the signals generated by the two accelerometers. FIG. 1(d) illustrates rotation of the wrist in the opposition direction. The two accelerometers will output signals of near-identical amplitude but of opposite polarity, This situation can be distinguished from that shown in FIG. 1(c) because of the absolute polarity of the signals from the two accelerometers. FIG. 1(e) shows a situation in which the user moves his wrist sideways. Accelerometers mounted as shown in FIG. 1 will not detect this movement. FIGS. 1(f) and 1(g) illustrate situations in which the user is both moving his wrist linearly and rotating it. Because the linear movement is likely to be faster than the rotation, both of the accelerometers will probably output a signal of the same polarity. However, accelerometer 16 will accelerate more quickly than accelerometer 18 and the difference in amplitudes allows the existence of the rotational motion to be detected. FIG. 1(g) illustrates a similar scenario in which the user is raising his wrist but is twisting his wrist in the opposite direction The polarity of outputs from the accelerometers 16, 18 will be the same as that for the situation shown in FIG. 1(f). However, in this case the signal from accelerometer 18 will have a greater amplitude than the signal from accelerometer 16, indicating to the control circuitry the direction of a twisting motion.

The situation shown in FIGS. 1(a) to 1(g) assume that the user's wrist is oriented in a particular way—for example palm vertical. This will not always be the case, of course, but the user will intuitively allow for this in operation. A further embodiment described below provides another solution to this problem.

FIG. 2 shows a block schematic diagram of a preferred embodiment of the bracelet unit. It should be noted, however, that the control circuitry described hereinafter with reference to FIGS. 3 and 4 may be wholly or partially incorporated into the bracelet itself It is preferred to provide the majority of the control functionality at the receiver end (FIG. 3) because this allows the cost of the bracelet units to be reduced. This is particularly significant should a bracelet unit be lost or damaged or where a number of bracelet units control a single appliance or group of appliances.

In FIG. 2, accelerometers 16 and 18 are connected via integrators 20 and 22 respectively to multiplexer (MUX) to provide velocity signals. The velocity signals are fed to a BlueTooth transmitter 26 which, in turn, is connected to antenna 28. BlueTooth is a low-power wireless transmission protocol which is ideally-suited to the present application. Further details can be found at www.bluetooth.com. While a BlueTooth transmitter and receiver combination are described, the present invention is equally applicable to other short-distance transmission techniques. Whether the arrangement shown is implemented entirely in digital circuitry or partially in analogue circuitry is not critical to the invention.

FIG. 3 shows a block schematic diagram of the control unit. Antenna 40 is connected to BlueTooth receiver 42 which in turn is connected to microprocessor 44. The microprocessor 44 will be provided with read only memory (ROM), random access memory (RAM), clock circuitry and so on. There are a large number of suitable microcontrollers available. Dotted components 46 and 48 illustrate an optional learning feature of the control unit. An IR receiver (IR RX) 48 is responsive to signals from the existing remote control unit. This allows a learning procedure to be performed and signal patterns are stored in microprocessor 44 Subsequently the microprocessor 44 controls and IR transmitter (IR TX) 46 to control the apparatus in response to signals received via receiver 40 from a bracelet unit.

Where the control unit is incorporated into an appliance which is already provided with a microcontroller, this microcontroller can advantageously be used to operate the interface. Whether the functionality is provided by a stand-alone microprocessor or as part of an existing microcontroller, FIG. 4 illustrates the steps performed.

The routine starts at step S10 and proceeds to step S12 at which a received signal from the user-mountable unit or units is detected. Processing proceeds to step S14 at which it is determined whether there is a signal above a threshold. Clearly it would be inconvenient for all movements of the user's wrist to trigger activation of the unit. If the outputs of the accelerometer are not above the predetermined threshold then processing proceeds to step S28 at which it is determined whether the bracelet has been switched off or removed. Whether the unit has been removed could be accomplished in a number of different ways, for example if no movement has been detected for a given time, such as 15 minutes or if the clasp (14, FIG. 1) has been undone or if an electrical skin-resistance sensor (not shown) located on an inside face of the unit indicates open circuit. If it is determined that the bracelet has been removed (or switched off) then processing proceeds to step S30 at which processing ends. If the bracelet is still determined to be in use then processing returns to step S12 at which a receive signal is sensed once more.

In the absence of accelerometer signals above the threshold, processing continues around his loop for as long as the bracelet is active. Alternatively, the routine could be interrupt-driven by a sensed signal from one or more user-mountable units. Such an interrupt-driven arrangement would be particularly suitable for a case where the interface functionality was provided by a microcontroller having other operational functions.

Once a sufficiently strong velocity (ie. integrated accelerometer) signal is detected, processing proceeds to step S16 where a reading is taken for sensor 1 and then to step S18 where a reading is taken for sensor 2. Optionally, some thresholding could be applied to the sensor signals at this stage. For example, sensor outputs could be placed in ranges such as slow, medium, fast or into another set of categories. The favoured number of categories to cover all the ranges of movement of the user's wrist is 3 but more (or fewer) are possible.

For certain applications it may be desired to apply no thresholding but to use a continuously-variable signal. Interactive games may benefit from such a feature.

Processing proceeds to a look-up step S20 in which the output values from sensor 1 and sensor 2 are applied to a set of rules to derive the intended output command. The lookup step could be implemented in a number of different ways, such as ROM-logic, a stored look-up table or possibly one or more algorithms to derive the desired output signal.

In the present embodiment, the user may perform a function by performing two distinct actions. This is analogous to the use of a SHIFT key on a keyboard. One particular motion, for example a rotation of the users wrist to the right (FIG. 1(c)) indicates to the controller that a further movement is awaited. Step S22 determines whether this is the case. If the function intended by the user is fully defined processing proceeds to step S24 at which the command is effected. Processing then proceeds to the original loop at step S28. However, if the command is not yet fully defined, in other words if a further movement is required, then a flag is set and processing proceeds to step S16. Steps S16, S18 and S20 are then used to determine the function. The flag which was set at S26 is used as an input to the look-up step at S20. The further motion added by the user can then complete the definition of the instruction which is then performed at S24. A number of levels could be provided in which case the loop S16, S18, S20, S22 and S26 is followed repeatedly. This clearly has the benefit of increasing the number of functions which can be instructed by the unit. However, it does have the disadvantage of becoming increasingly complex to operate. In a preferred embodiment there is only one “SHIFT” so that the loop S16 to S26 is traversed only once before the decision “YES” is taken at S22.

FIG. 5 shows a television set 50 upon which a viewer is watching a motor racing programme. The viewer wishes to alter the volume of the sound generated by the set 50. He or she activates his bracelet unit (for example by pushing a button or performing a particular predetermined action) and the indication 52 (VOL ||||||||||) appears on the screen. A thickened indicator 54 illustrates the current volume level. Appropriate movement of the user's wrist will then alter the volume level up or down as desired. Similar visual indications will appear to indicate changes of channel, contrast, brightness and so on. The indication 52 will disappear from the screen a short while after no further adjustment is detected from the user. Where the remote control is controlling a unit with no screen (the amplifier in a hi-fi system, for example) there will be no visual interface.

FIG. 6 shows an alternative means for measuring bracelet movement. A sectional plan view of a television set 60 (which incorporates all of the usual components, although these are not shown here for reasons of clarity) includes an ultrasonic radar unit 66 connected to transducers 62 and 64. At a point in front of the set 60 there is located a bracelet 10. The bracelet 10 includes means for receiving the ultrasound signals and means for retransmitting such signals. A very simple transponder arrangement can therefore be used. In order to determine the position of the bracelet 10, the radar unit 66 transmits a frequency modulated continuous wave signal whose frequency has a saw-tooth pattern. This is also known as a “chip” signal. The signal is emitted by, for example, transducer 62 and, once it has been returned by the bracelet 10 a return signal will be sensed by the transducer 62. Because of the time lag involved in the round-trip transmission (and any transponder delay at the bracelet 10) the frequency of the return signal will be lower than that of the outgoing signal. Provided that the frequency characteristics of the chirp signal are linear there will be a linear relationship between the difference in frequency values and the distance of the bracelet from the set 60 (assuming a negligible transponder delay). By also performing the procedure from transducer 64 the location of the bracelet 10 can be determined (at least in the horizontal plane). This feature allows the position of the bracelet 10 to be determined as well as the movement of the bracelet. This can be used in its own right or in conjunction with bracelet-based sensors as previously described.

FIG. 7 shows a view similar to that shown in FIG. 1 but of another embodiment of a bracelet 100. The bracelet contains four accelerometers 116, 118, 124 and 126 as well as a gravity switch 122 and a push-button 128. By providing the gravity switch (for example a mercury switch) 122 and four accelerometers it is possible to allow for the problem of orientation of a user's wrist discussed previously. The gravity switch 122 informed the unit 120 (at least approximately) which way the bracelet is oriented. The provision of accelerometers on an extra axis allows the movement of the user's wrist to be detected even when one pair of accelerometers is reading zero (because there is no movement in the relevant plane). Optionally, one of the accelerometers can be a two-dimensional device oriented within the bracelet such that it can also detect fore and aft movement As illustrated in FIG. 7 this would be movement in and out of the plane of the paper.

Because twisting motion can be detected by accelerometers in either plane it may be possible to provide the requisite functionality with three acceleration sensors.

The push-button 128 is intended to be operated by the user's other hand. It may be used as an ON/OFF switch or for other functions (e.g. a “fire” button in an interactive game).

1. A unit for mounting on a user's forearm comprising at least one sensor for detecting movement of a user to which the unit is mounted and a wireless communication means for transmitting a signal in response to such movement.

2. A unit as claimed in claim 1, wherein the wireless communication means comprise a short-range radio transmitter.

3. A unit as claimed in claim 2, wherein the short-range radio transmitter comprises a Bluetooth transmitter.

4. A unit as claimed in claim 1, wherein the unit comprises means for attachment to a user's wrist.

5. A unit as claimed in claim 4, wherein the unit comprises a bracelet.

6. A unit as claimed in claim 1, wherein the at least one sensor for detecting movement of the user comprises an accelerometer.

7. A unit as claimed in claim 1, wherein the at least one sensor for detecting movement of the user comprises a pair of sensors arranged substantially opposite to one another.

8. A unit as claimed in claim 1, wherein the at least one sensor for detecting movement of the user comprises four sensors arranged at different points within the unit.

9. A unit as claimed in claims 1, further comprising means for determining the absolute orientation of the unit.

10. A unit as claimed in claim 9, wherein the means for determining the absolute orientation of the unit comprises a gravity switch.

11. A unit as claimed in claim 1, further comprising a manually-actuable switch.

12. A unit as claimed in claim 11, wherein the manually-actuable switch comprises an ON/OFF switch.

13. A unit as claimed in claim 1, further comprising means for deriving a plurality of control signals in response to movement of the unit.

14. A control unit for use with at least one unit as claimed in claim 1, the control unit comprising means for receiving a wireless communication from the user-mountable unit and means for deriving a plurality of control signals in response that communication.

15. A control unit as claimed in claim 14, further comprising means for determining the position of the user-mountable unit relative to the control unit.

16. A control unit as claimed in claim 15, wherein the means for determining the position of the user-mountable unit comprises ultrasonic radar.

17. A control unit as claimed in claim 14, wherein the means for receiving wireless communication are responsive to signals from a plurality of units as claimed in claim 1.

18. A method of interpreting signals provided by a unit as claimed in claim 1, comprising comparing the output of the at least one sensor with a plurality of ranges of sensor output and outputting a control signal associated with a range into which the sensor value falls.

19. A method as claimed in claim 18, further comprising a step of determining a sensor output in response to at least one of the sensor output values.

20. A set of processor-implementable instructions for implementation by a processor to carry out the method as claimed in claim 18.

21. A carrier medium carrying the set of processor-implementable instructions as claimed in claim 20.
